(19) United States
(12) Patent Application Publication
(10) Pub. No.: US 2008/0249729 A1
(43) Pub. Date: Oct. 9, 2008

(54) Systems and methods for real time hot mix asphalt production

(76) Inventors: David Frederick Martinez, Cypress, TX (US); Elias George Eldahdah, Houston, TX (US)

Correspondence Address: David F. Martinez;ATSER, 1150 Richcrest Drive, Houston, TX, 77060, US

(21) Appl. No.: 11/518,533

(22) Filed: Sep. 8, 2006

Related U.S. Application Data
(63) Continuation-in-part of application No. 10/808,736, filed on Mar. 18, 2004, now Pat. No. 7,104,142.
Application No. 10/808,736 is a continuation of application No. 10/155,484, filed on May 24, 2002, now Pat. No. 6,711,957.

(51) Int. Cl. G06F 19/00; G01N 3/08

(52) U.S. Cl. 702/84; 73/824

(57) ABSTRACT

A computer-implemented system performs analysis on a construction material mixture includes accessing a server located on a wide-area-network; sending information collected from the material mixture to the server; applying one or more test methodologies to the collected information; generating one or more reports from the test methodologies; and sending the one or more reports to a project manager.

This application is a continuation in part of application Ser. No. 10/808,736, filed Mar. 18, 2004 which is a continuation of application Ser. No. 10/155,484 now issued as U.S. Pat. No. 6,711,957.

The present invention relates generally to apparatus for manufacturing and deploying hot mixed asphalt materials and compositions.

### BACKGROUND

As modern commerce depends on reliable and cost-effective methods for delivering products from suppliers to users, the availability of durable and reliable highways, roads and other support surfaces for vehicles is vital for sustaining a modern economy. To provide better support surfaces, highways, roads, and sidewalks are commonly paved with a layer or mat of asphalt concrete which is laid over the surface of the sub-base. Asphalt is preferred over cement to pour roads because it is less expensive and very durable. Asphalt can also be poured at night, which allows major roads to be shut down at the least busy of times for maintenance. Asphalt is also quieter than cement, making it the better choice for roads.

Typically, the asphalt concrete comprises asphalt cement combined with aggregates in a ratio of approximately 95 parts by weight of aggregate to approximately 5 parts by weight of liquid asphalt cement. The asphalt cement is used to bind together the aggregate material and limit its mobility when a load is applied. The aggregate is usually a mixture of sand, gravel, and stone; the largest pieces of aggregate having a diameter equal to about ⅔ the thickness of the asphalt mat. Preferably, the aggregate has crushed particles to provide sharp edges in the gravel and stone which, when combined with the liquid asphaltic cement, create an aggregate interlock which improves the strength of the mat. The aggregate and liquid asphalt cement are heated and mixed to form an asphalt paving composition called hot-mix asphalt (HMA).

The HMA material used in highway construction and the like ideally consists of a uniform mixture of several sizes of mineral aggregate and liquid bituminous asphalt cement. When properly blended in the correct proportions, the HMA material provides a uniform and durable material that is capable of withstanding heavy traffic and loads over a long service life. In the process of producing the HMA material and delivering it to a construction site for placement by an asphalt paver, however, the mixture may tend to separate into its constituent parts, a condition commonly referred to in the industry as “segregation”.

As noted in U.S. Pat. Nos. 4,867,572 and 6,007,272, the HMA material produced at the production plant is often loaded into a storage silo to await trucks for transport to the construction site. As the HMA material is carried by a conveyor to the top of the silo, the larger sized aggregate contained in the HMA material tends to separate from the smaller sized aggregate material contained therein. Further, as the HMA material is dropped from the conveyor into the silo, the larger sized aggregate tends to roll to the lower periphery of the pile of HMA material typically forming a pyramid near the center of the silo, while the smaller sized aggregate tends to cling to the top and sides of the pile. The HMA material within the silo is, therefore, no longer a uniform mixture as desired but, instead, is a segregated mixture consisting of a surplus of larger sized aggregate near the outer wall of the silo and a paucity of larger sized aggregate nearer the center of the silo.

Similarly, as the HMA material is discharged from the silo into trucks for transport, larger sized aggregate tends to roll to the extreme comers of the truck box while the smaller sized aggregate tends to remain more toward the center of the truck box. The truck therefore contains a segregated mixture consisting of a surplus of larger sized aggregate at the front, rear and sides of the truck box and a paucity of larger sized aggregate nearer the center of the truck box.

An asphalt paver at the construction site is a self-propelled construction machine designed to receive, convey, distribute, profile and partially compact the HMA material. The paver accepts the HMA material into a receiving hopper at the front of the machine, conveys the material from the hopper to the rear of the machine with parallel slat conveyors, distributes the HMA material along the width of an intended ribbon or mat by means of two opposing screw or spreading conveyors, and profiles and compacts the HMA material into a mat with a free-floating screed.

Each slat conveyor that moves the HMA material from the receiving hopper to the rear of the paving machine generally consists of two parallel slat chains with a multitude of transverse slats connected there between. Each slat chain is pulled by one of two sprockets mounted on a common shaft which, in turn, is driven by appropriate power transmission chains, gear boxes or the like. Because the slat conveyor pulls the HMA material from the hopper in a bulk mass with little or no remixing, any segregated characteristics of the HMA material as it exists in the hopper continues to exist in the HMA material as it is placed by the opposing screw conveyors on the subgrade in front of the screed.

When the undesirably segregated, HMA material is delivered to the construction site and placed by the asphalt paver, the mat produced is not of uniform consistency but, instead, contains regions having a surplus of larger sized aggregate and a paucity of smaller sized aggregate and, likewise, regions with a surplus of smaller sized aggregate and a paucity of larger sized aggregate. As a result, the mat produced from the segregated material does not possess the desired mechanical properties and generally will not withstand the anticipated loads and stresses as well as a mat constructed of non-segregated, or uniform, HMA material. What is needed is an apparatus that is capable of, and a method for, remixing segregated HMA material just before the HMA material is placed on a subgrade by an asphalt paver whereby the detrimental effects of segregation are substantially or totally eliminated.

After the pavement has been constructed, it is checked for compliance with quality requirements specified by the purchasing agency. In the past, agencies have conducted both quality control (QC) and quality assurance (QA) testing. However, that role is increasing being shifted to contractors.

### SUMMARY

In one aspect, a computer-implemented method to monitor pavement hot-mix material quality includes collecting quality control data in real-time from one of: a plant, a truck, a lay-down equipment, a paver; accessing a server located on a wide-area-network; sending information collected from the materials, components or blends to the server; applying one or more test or inspection methodologies to the collected information; generating one or more quality management reports from the test methodologies; and sending the one or more quality management reports to a reviewer.

Implementations of the aspect may include one or more of the following. The method can provide an Internet browser interface to access the server located on the wide-area-network. The computer-implemented method can apply in general to asphalt concrete, concrete and soils aggregate test and inspection methodologies. The aggregate test methodologies can include any testing methodologies with one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

Advantages of the system may include one or more of the following. The system allows a user to analyze material testing data from beginning to end using one centralized resource. This makes the material testing process easier to understand for the user and allows the user to control and monitor progress relating to the analysis of the materials.

The system completes a material analysis transaction with many users, keeping track of what each user is doing and progress. In one embodiment, the centralized web-based system allows the entire process to be accessible from one central location on a network. The system is also efficient and low in operating cost. It also is highly responsive to user requests by providing alerts based on events or test results.

The system provides Total Quality Management in Real Time that includes management, design and construction key performance indicators. The requirement management system identifies random audit samples to be taken and evaluated for compliance. This information is collected and reported in Real Time and the system makes use of a Real Time Quality Score Card. The owner can be confident that the project requirements comply with requirements from material specifications and project quality assurance documents.

The system enables hot-mix facilities to maintain high-caliber testing laboratories. QC and QA testing can include measuring HMA component and other physical properties. Laboratory compaction of field produced mix and the resulting volumetric properties can be used for QC and QA. The system can use asphalt ignition ovens to provide component analyses into QC and QA plans.

Other advantages and features will become apparent from the following description, including the drawings and claims.

### BRIEF DESCRIPTION OF THE DRAWINGS

FIG. 1 shows an exemplary system to monitor HMA quality.

FIG. 2 shows an exemplary plant data collection and real-time hot mix property management system.

FIG. 3 shows an exemplary real-time compaction and hot-mix mixture properties estimation process.

FIG. 4 shows one embodiment of a process for processing material test information.

FIG. 5 shows an exemplary system that provides a cost-effective approach to manage quality assurance.

FIGS. 6A-6C show exemplary QA/QC reports for total quality management.

### DESCRIPTION

Referring now to the drawings in greater detail, there is illustrated therein structure diagrams for a laboratory information management system and logic flow diagrams for the processes a computer system will utilize to complete various material tests. It will be understood that the program is run on a computer that is capable of communication with consumers via a network, as will be more readily understood from a study of the diagrams.

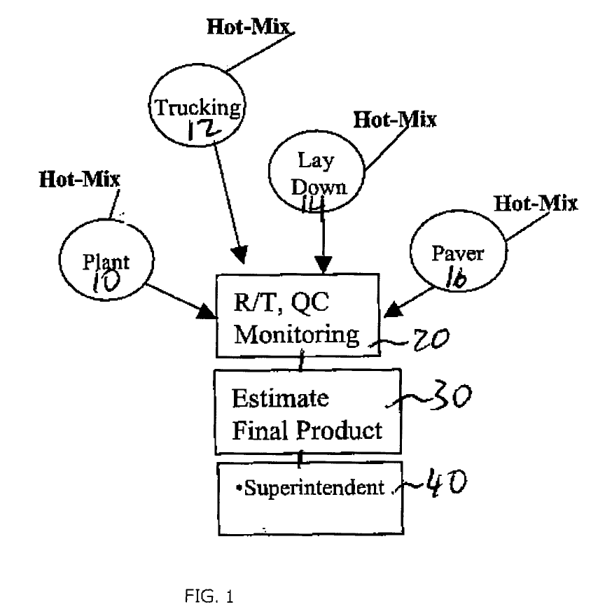

FIG. 1 shows an exemplary system to monitor HMA quality. In this system, sensors placed in an HMA plant 10 relay real-time quality monitoring control specifications or parameters to a real-time quality control monitoring server 20. Similarly, sensors placed on an HMA truck 12, a lay-down machine 14, and a paver 16 relay real-time quality monitoring control specifications or parameters to the real-time quality control monitoring server 20. The sensors in the plant 10, the truck 12, the lay-down machine 14, and the paver 16 measure HMA temperature, thickness, ride, mix properties, profile and segregation of the HMA materials. For example, sensors for mix properties can sense volume, strength, FAT and moisture, among others. The information from all sources is provided to the real-time quality control monitoring system 20, whose output is provided to an estimator module 30 to predict the HMA material output. The result is eventually provided to an agency or a contractor superintendent 40.

The system of FIG. 1 estimates mixture properties in real times so the hot mix plant operator can adjust the plant settings to improve quality or to comply with required specifications. The system determines the specific gravity and gradation/size analysis in real time to determine the hot mix properties in real time at the hot mix plant. This allows the plant operator to adjust the hot-mix at the plant before it gets to the roadway out of specification. The system measures real time hot-mix properties along with grain size analysis. This information allows us to predict properties.

The asphalt plant 10 includes equipment for heating and drying virgin aggregate and equipment for mixing the heated and dried aggregate together with liquid asphalt to form a paving composition. Optionally, recycleable asphalt pavement (commonly referred to as “RAP”) is also included in the mix. The RAP must be heated sufficiently to melt the asphalt therein so that the components of the RAP can become thoroughly intermixed with the virgin aggregate and liquid asphalt.

The asphalt plant 10 can be batch plants or, more commonly, continuous-mix plants. In a batch plant, a quantity of virgin aggregate is heated and dried and dumped into a mixer along with a proportional quantity of liquid asphalt. The batch of aggregate and liquid asphalt is then thoroughly mixed and discharged into a storage bin so that the next batch can be prepared. In a continuous-mix plant, ingredients are continuously being introduced into the plant, and asphalt paving composition is continuously being discharged from the plant, rather than manufacturing the asphalt paving composition in batches. Since materials are continuously being introduced, the proportions of the components in the mix must be controlled by controlling the relative rates at which the various components are introduced into the plant, rather than by merely controlling the relative quantities of the various components. Continuous-mix plants generally fall into one of two categories. In the first type of continuous-mix plant, virgin aggregate is heated and dried in a drum dryer. The heated and dried aggregate is then discharged into a separate mixing device, such as a pugmill. Liquid asphalt is then introduced into the mixer along with the aggregate and is thoroughly mixed, the resulting asphalt paving composition being discharged from the other end of the mixer.

In a second type of continuous-mix plant, known as a “drum mixer,” the drying and mixing processes are both carried out in a single rotating drum. Virgin aggregate is introduced into the upper end of the rotating drum. A burner mounted in the upper end of the drum heats the air flowing through the drum, and the aggregate is heated and dried as it is tumbled through the heated airflow in the upper end of the drum. Liquid asphalt is introduced into the drum at a point sufficiently removed downstream from the burner so that the liquid asphalt will not smoke. The heated and dried aggregate and the liquid asphalt are then mixed in the bottom portion of the drum, and the asphalt paving composition is discharged out the lower end of the drum. Air removed from the drum is typically ducted to a dust-collection system, such as a baghouse, wet-washer, or cyclone separator.

The truck 12 can be heavy-duty equipment with insulated beds, multiple axles carrying heavier loads, and automatic covers to control heat loss from the mix has lowered the costs of transportation. Two-way radios and mobile telephones are used to improve truck fleet management. In one embodiment, positional data on each truck can be realized through use of the Global Positioning System (GPS). The ability of GPS to provide location-specific information will enable logistical analyses that can reduce time lost in transit when plant stoppages occur or job requirements change. In areas of lower traffic volume or large projects, bottom-dump or conveyor-flow semi-trailers can be used to carry more tons per load. Bottom-dump trailers deposit the HMA on the existing pavement in a windrow; a pickup or transfer device is required to deliver the mix to the paver 16. Trailers with conveyors can unload directly into the paver 16 or into a load transfer device.

At the job site, temperature sensors are used to address the temperature-segregation relationship. The truck fleet management tools can be coordinated with the speed of the paver 16 to avoid strings of trucks waiting to unload. On a large job, load transfer devices can smooth out the paver operation and permit faster truck unloading. These machines not only transfer the material, but also reduce segregation through their remixing action.

The paver 16 are becoming more productive and sophisticated. In one embodiment, computerized controls regulate the various paver functions from the hopper to the screed. Smoother mats are being obtained through use of a rolling beam or sensing instruments.

In one embodiment, tandem-drum vibratory rollers for compaction are used. One or two breakdown rollers can be operated immediately behind the paver 16 to achieve maximum density before heat is lost from the mix. Intermediate roller patterns often incorporate a pneumatic or rubber-tired roller to obtain further density. When tender mix behavior is encountered, as has been the case with some Superpave mixtures, the intermediate roller is often removed from the compaction train. A finish roller is then used to smooth the mat.

The real-time quality control monitoring system 20 is connected to a wide area network such as the Internet as well as to a local area network such as a WiFi network, for example. The server 20 can receive data from the plant 10, the truck 12, the lay-down equipment 14, and the paver 16 using modems such as RF modems. In one embodiment, land-line modems are used. In other embodiment, wireless modems such as cellular modems are used. In yet other embodiments, 802.11X can be used to provide wireless LAN connection with the server 20. In yet other embodiments, a combination of cellular and 802.11 modems can be used to connect plant 10, the truck 12, the lay-down equipment 14, and the paver 16 to the server 20.

One or more client workstations are also connected to the network. The client workstations can be personal computers or workstations running browsers such as Netscape or Internet Explorer. With the browser, a client or user can access the server 20's Web site by clicking in the browser's Address box, and typing the address (for example, www.atser.com), then press Enter. When the page has finished loading, the status bar at the bottom of the window is updated. The browser also provides various buttons that allow the client or user to traverse the Internet or to perform other browsing functions.

An Internet community with one or more building construction companies, service providers, manufacturers, or marketers is connected to the network and can communicate directly with users of the client workstations or indirectly through the server 20. The Internet community provides the client workstations with access to a network of test service providers.

Although the server 20 can be an individual server, the server 20 can also be a cluster of redundant servers. Such a cluster can provide automatic data failover, protecting against both hardware and software faults. In this environment, a plurality of servers provides resources independent of each other until one of the servers fails. Each server can continuously monitor other servers. When one of the servers is unable to respond, the failover process begins. The surviving server acquires the shared drives and volumes of the failed server and mounts the volumes contained on the shared drives. Applications that use the shared drives can also be started on the surviving server after the failover. As soon as the failed server is booted up and the communication between servers indicates that the server is ready to own its shared drives, the servers automatically start the recovery process. Additionally, a server farm can be used. Network requests and server load conditions can be tracked in real time by the server farm controller, and the request can be distributed across the farm of servers to optimize responsiveness and system capacity. When necessary, the farm can automatically and transparently place additional server capacity in service as traffic load increases.

The server 20 can also be protected by a firewall. When the firewall receives a network packet from the network, it determines whether the transmission is authorized. If so, the firewall examines the header within the packet to determine what encryption algorithm was used to encrypt the packet. Using this algorithm and a secret key, the firewall decrypts the data and addresses of the source and destination firewalls and sends the data to the server 20. If both the source and destination are firewalls, the only addresses visible (i.e., unencrypted) on the network are those of the firewall. The addresses of computers on the internal networks, and, hence, the internal network topology, are hidden. This is called “virtual private networking” (VPN).

The server 20 allows a user to log onto a computerized laboratory analysis software package incorporating AASHTO, ASTM or a state agency version of standard test methods for Quality Assurance/Quality Control of soils, aggregates, asphalt, cement asphalt and concrete mixes. Information relating to the various portions of a transaction are captured and stored in a single convenient location where it can be accessed at any time.

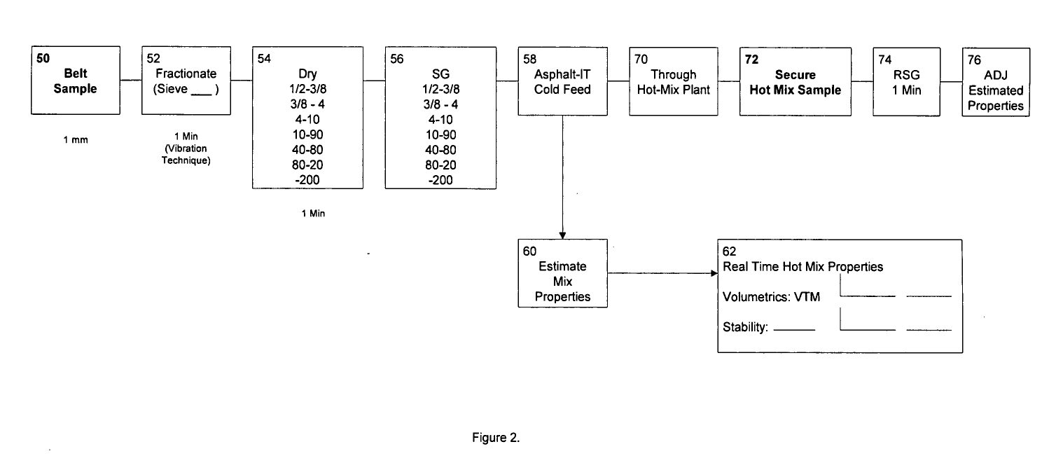

FIG. 2 shows an exemplary plant data collection and real-time hot mix property management system. Aggregates are sampled from a belt (50). Next, the aggregates are fractionated (52). For example, the aggregates can be separated using vibratory techniques. Next, the aggregates are dried (54). The samples are then separated into SG (56). Next, the aggregates are analyzed using a cold feed (58). Based on the cold feed data, the process estimates mix properties (60). The data is presented to a real-time hot mix property management system (62).

Also, from operation 58, the aggregates are provided to a hot-mix plant (70). A sample of the hot-mix is secured (72), and an RSG operation is performed (74). The output of operation 74 is presented to estimate HMA properties (76). The output of operation 76 is also provided to the real-time hot mix property management system.

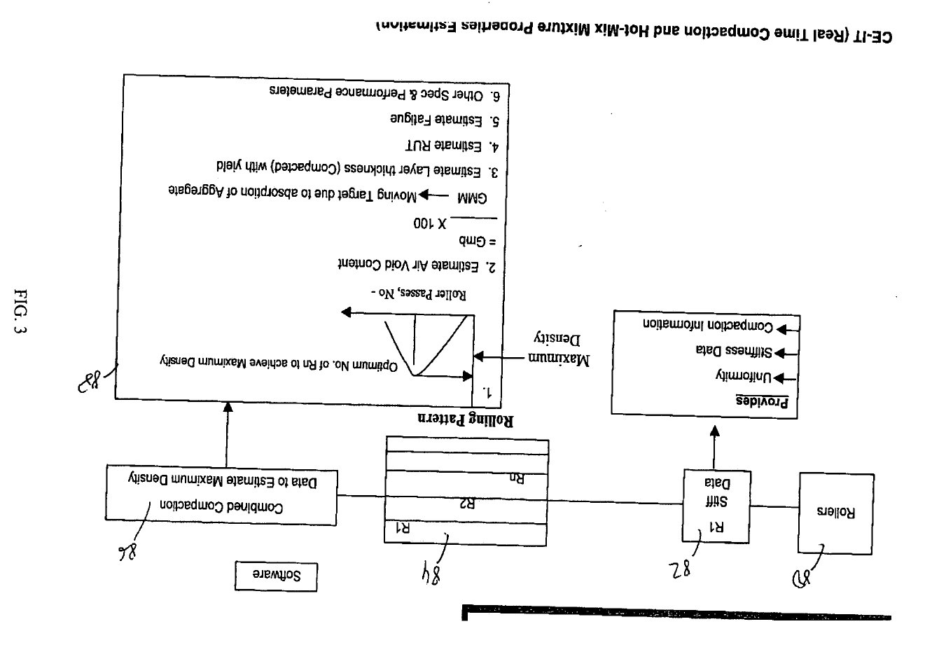

FIG. 3 shows an exemplary real-time compaction and hot-mix mixture properties estimation process. First, the HMA material is fed through rollers (80). Next, stiff data is collected (82). The stiff data includes uniformity data, stiffness data, and compaction data, among others. Various roller pattern performance data is collected (84). The process combines the compaction data to estimate maximum density (86). Based on the collected data, the system of FIG. 1C estimates air void content, layer thickness, RUT, fatigue, and other specification and performance parameters (88).

The system of FIG. 3 makes use of hot mix placing operations. The rollers can record resistance and unable to determine thickness. This approach allows the compaction data to be captured in real time and makes use of some device to determine pavement thickness prior to placement of fresh hot-mix. Most often specification requires hot mix consolidated thickness (i.e. the thickness of the hot-mix after rolling intended for compaction is completed). This technique makes use of Asphalt-It equation (PLS PROVIDE) and technique attached to the rollers or GPS to estimate thickness and compaction and other hot-mix properties during actual rolling. Preferably the thickness of the final mat must be estimated on the pavers. The system estimates important properties during the times an operator can make adjustments to minimize the occurrence of out of compliance material, before it reaches the point of no return during pavement operations.

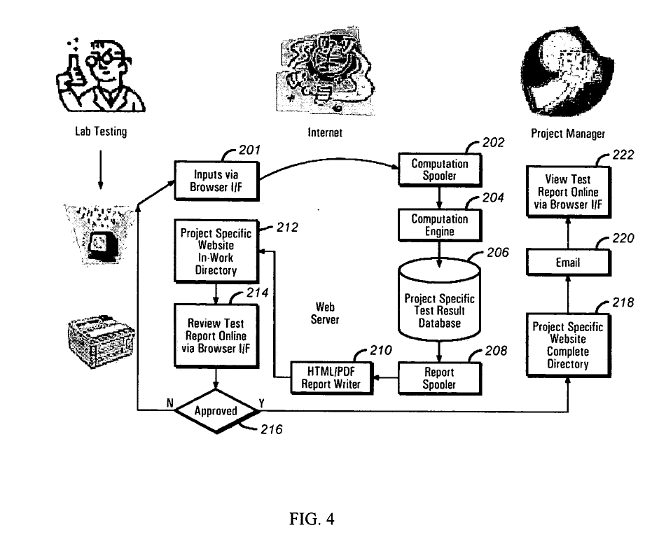

FIG. 4 shows an exemplary process 200 for providing a network-based Laboratory Information Management System (LIMS) on the server 100. First, browser based user interfaces are used to collect test result inputs (step 201). These inputs are collected by the server 100 and provided to a computation spooler (step 202). The spooler activates a computation engine performing the appropriate engineering calculation (step 204) and writes this information to a project specific test result database (step 206). The process 200 then activates a report spooler (step 208). The report spooler then sends output information to a report writer that stores this information in an In-Work directory for each project for review by a lab manager (step 210). In one embodiment, the report writer can generate HTML or PDF documents for viewing.

The lab manager classifies the test results (step 212). Unapproved test results will require updates to the test inputs, recalculation of results, and re-posting of the information to the In-Work website directory. Approved test reports will be promoted to the completed directory on a project specific website. The project specific website directories provide for data security and separation of client's project specific information. The process 200 sends an email notification to a Project Manager for viewing of the final report online (step 214).

The computer-implemented method can apply one or more test methodologies, for example aggregate test methodologies. The aggregate test methodologies can include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

By supporting a plurality of test methodologies, the process of FIG. 3 offers a comprehensive laboratory analysis incorporating AASHTO and ASTM standard test methods for Quality Assurance/Quality Control of soils, aggregates, asphalt, cement asphalt and concrete mixes.

The computer-implemented method can apply aggregate test methodologies. The aggregate test methodologies can include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate. The method can include comprising applying soil test methodologies. The soil test methodologies can include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test. The method can include applying asphalt test methodologies. The asphalt test methodologies can include one or more of the following: Extraction; AES300 Emulsion Test; and ARA-1 Rejuvenate Agent. The method can include applying asphalt mix test methodologies, wherein the asphalt mix test methodologies can in turn include one or more of the following: Ignition Test; Actual Specific Gravity; Theoretical Maximum (Rice) Specific Gravity; Tensile Strength Ratio; Marshall Stability; Hveem Stability and Voids Calculation. The method can apply concrete mix test methodologies. The concrete mix test methodologies can include one or more of the following: Unit Weight, Yield, Air Content of Mix; Flexural Strength; Compressive Strength of Cylindrical Concrete Specimens; and Air Content.

In one implementation, the following aggregate calculations are done. The Los Angeles Abrasion method covers the procedure for testing coarse aggregate for resistance to degradation using the Los Angeles testing machine, as defined in AASHTO T96, ASTM C131. The soundness test measures aggregate resistance to disintegration according to AASHTO T104. The 24 Hour Water Absorption test method covers the determination of specific gravity and absorption of coarse aggregate pursuant to AASHTO T85-91, ASTM C127-88. The sand equivalent serves as a rapid field test to show the relative proportion of fine dust or claylike material in soils or graded aggregates. The Unit Weight and Voids in Aggregate test method covers the determination of unit weight in a compacted or loose condition and calculated and in fine, coarse, or mixed aggregates based on the determination under ASTM C29, AASHTO T19. The specific gravity, water absorption and moisture method is used to determine the bulk specific gravity and water absorption of aggregate retained on a No. 80 sieve, as defined in ASTM T84. The clay lumps and friable particles in aggregate method covers the approximate determination in clay lumps and friable particles in natural aggregates, per AASHTO T112-91. The sieve analysis method is used to determine the particle size distribution of aggregate samples, using sieves with square openings under ASTM C136, ASSHTO T27

For soils, the Soil Liquid, Plastic Limit and Plasticity Index procedure determines the liquid limit of soils, defined as the water content of a soil at the arbitrarily determined boundary between the liquid and plastic states, expressed as a percentage of the oven-dried mass of the soil. It also determines the plastic limit and plasticity index in soil as defined in ASSHTO T89, 90, 91. The Material in Soil Finer than #200 Sieve method determines the amount of soil material finer than the 75 μm (No. 200) sieve under AASHTO T11, ASTM D1140. The Moisture and Density of Soil-Aggregate In-Place by nuclear method covers the determination of the total or wet density of soil and soil aggregate in-place by the attenuation of gamma rays. The Moisture Content method covers the laboratory determination of the moisture content of soil under AASHTO T265. The specific gravity of soils method covers the determination of the specific gravity of soils by means of a pycnometer under AASHTO T100-95, ASTM D854-83 The Unconfined Compressive Strength of Cohesive Soil method covers the determination of the unconfined compressive strength of cohesive soil in the undisturbed, remolded, or compacted condition as discussed in AASHTO T208-96, ASTM D2166-85. The sieve analysis of fine and coarse aggregates method covers the determination of the particle size distribution of fine and coarse aggregate by sieving, as discussed in AASHTO T27-97, ASTM C136-95A. The compaction test is intended for determining the relation ship between the moisture content and density when compacted under ASSHTO T99, T180, ASTM D698, D1557. The California Bearing Ratio (CBR) method covers the determination of the (CBR) of pavement subgrade, subbase, and base/course material from laboratory compacted specimens under AASHTO T193-98. The density and unit weight of soil in place by the sand-cone method may be used to determine the in-place density and unit weight of soils using a sand cone apparatus as discussed in ASTM D1556.

For asphalts, the extraction method covers the recovery by the Abson method of asphalt from a solution from a previously conducted extraction (ASTM D1856, ASHTO T170). The emulsion test is described under the headings titled Composition, Consistency, Stability, and examination of residue of ASTM 244, ASSTO T59.

For asphalt mix, the ignition test method covers the determination of asphalt content of hot-mix asphalt (HMA) paving mixtures and paving samples by removing the asphalt content at 540 C by ignition in a furnace, per ASTM D6307-98. The actual specific gravity (BSG, Gsb) test method covers the determination of bulk specific gravity of specimens of compacted bituminous mixtures, per AASHTO T166. The theoretical maximum (Rice, or Gmm) specific gravity test method covers the determination of the theoretical maximum specific gravity and density of uncompacted bituminous paving mixtures at 25 C pursuant to AASHTO T209. The tensile strength ratio method covers preparation of the specimens and measurement of the change of diametral tensile strength, per AASHTO T283-89. The Marshall stability test method covers the measurement of the resistance to plastic flow of cylindrical specimens of bituminous paving mixture loaded on the lateral surface by means of Marshall apparatus, per ASTM D1559-89. The Hveem Stability test methods cover the determination of (1) the resistance to deformation of compacted bituminous mixtures by measuring the lateral pressure developed when applying a vertical load by means of Hveem stabilometer, and (2) the cohesion of compacted bituminous mixtures by measuring the force required to break or bend the sample as a cantilever beam by means of the Hveem cohesiometer, per ASTM D1560-92. The voids calculation method covers determination of the percent air voids in compacted dense and open bituminous paving mixtures, as described in AASHTO T269.

The concrete mix test includes the Unit Weight, Yield, and Air Content of Concrete Mix test method that covers determining the weight per cubic meter (cubic yard) of freshly mixed concrete and gives formulas for calculating yield, cement content, and air content of the concrete. Except for editorial differences, this procedure is the same as ASTM C 138 and AASHTO T 121. The Quality of Water to be used in Concrete test method tests for acidity or alkalinity, per AASHTO T26-79. The Compressive Strength of Cylinder Concrete Specimens method covers determining compressive strength of cylindrical concrete specimens such as molded cylinders and drilled cores. The flexural strength of concrete test method covers the determination of flexural strength of concrete by the use of a simple beam with third-point loading, per AASHTO T97-86, and ASTM C78-84. The air content method determines the air content of freshly-mixed concrete by observation of the change in volume of concrete with a change in pressure, as described in AASHTO T152-97 and ASTM C231-91B.

The process of FIG. 4 also includes full automatic report generation capability with forms stored within the system. Graphing capabilities include Proctor, PI test, Control Chart, statistical and standard deviation analysis and others. The software can statistically compare test results. Statistical comparisons are performed by over-plotting the contractors' quality control test results and the owners' quality acceptance results. Statistical test are then performed to evaluate the mean, standard deviation, sample size, test frequencies, cumulative frequencies, percent within-limit, percent out-of-limit, F-test (variability testing), T-test (means testing). These statistical tests are important for contractors and owners to determine pay factor adjustments and to assess the level of owners risk in material acceptance.

As part of the quality control, gyratory compaction tests may be performed. Since the 1930's, gyratory compaction has been used in asphalt mixture design under a procedure developed by the Texas Department of Transportation. The number of gyrations are expected to simulate pavement density at the end of life. The original gyrator compaction procedure was done manually. In the late 1950's-early 1960's, mechanized compactors were developed. These gyrators typically applied gyrations continuously while holding vertical pressure constant. In certain models, gyrations continue until the ratio of height change per revolution decreases below a predetermined limit. Other criteria for applying the gyrations include maintaining a constant angle during compaction, a constant vertical pressure, and a constant rate of gyration.

In one embodiment, gyratory compaction is done. First, the user selects a gyratory equipment type. The equipment can be a unit commercially available from a variety of vendors, including Test Quip, Inc. of New Brighton, Minn.; Rainhart Company of Austin, Tex.; Pine Instrument Company of Grove City, Pa.; and Troxler Electronic Laboratories, Inc. of Research Triangle Park, N.C. Next, the user sets up communications port with the selected equipment. The user selects a display mode: Real Time or Import from a file. The user then selects a test type, in this embodiment a Trial Blend type or Design Binder Content type. Additionally, the user selects a blend number and specimen number. When the user is ready to run a test, the user clicks on an “Info” button to enter the information on the gyratory session. This information can also be entered after a test. The user then turns on the communication port, and review and check data generated by the gyratory equipment.

The system can also perform ignition tests on materials. The process supports a communication link between ignition furnaces to record chamber temperature, % weight loss, and calibrated % AC in a real-time tracking mode. In one exemplary implementation, the user selects and turns on a particular communication port. Next, the user can capture the test results from a particular ignition test equipment through the selected port. Clicking on a “RECORD” button allows the user to see the test in real time. The user can also view a by-the-minute recording of the test after it is complete. After completion, the user can save the captured information. The user can select FILE and the Save from the menu bar to save the test results, first as a sequential file, and then select “Save to Database” to add it to an ignition database. The user can also print results to the printer. Next, the user can select View Database to view the Test results database of all tests completed. The tests are shown in order from last completed in one embodiment.

The user can also select a “Sieve Analysis” option, which allows the user to input sieve data and track results easily. After inputting results, the user can select “Calculate” to get output. The user can also specify a “Balance settings” option to initialize a communications interface to an electronic balance for sieve weights.

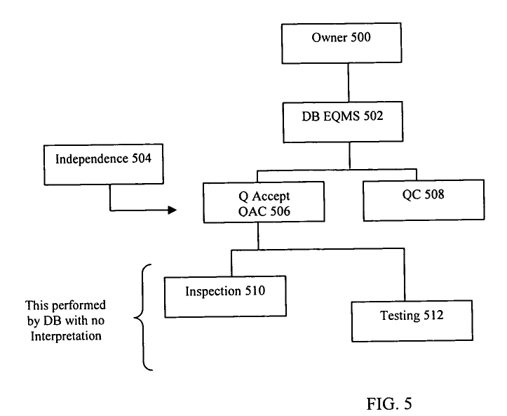

FIG. 5 shows an exemplary system that provides a cost-effective approach to manage quality assurance (i.e., QAC, QC, IA, OAT, ETC.) with an automated system that provides independence and cost effective inspection and testing. In the embodiment of FIG. 5, an owner or project manager 500 communicates with a database 502 on quality management. The database 502 in turn communicates with a quality acceptance system 506, which also receives independent quality data 504. The database 502 also communicates with a quality control system 508. The quality acceptance system 506 in turn receives data from an inspection system 510 and a testing system 512. The inspection system 510 and/or the testing system 512 can operate automatically without human interpretation by using predetermined programming/algorithms/heuristics, neural networks, self-learning systems, or expert systems, among others. The owner can be confidant that the project requirements comply with its requirements. The system also provides tools as part of a cost-effective approach to manage quality assurance (i.e., QAC, QC, IA, OAT, ETC.). For example, automated systems 510-512 provide independent and cost effective inspection. A status report can be generated for managing, designing, and construction processes. The system can also be used to develop parameters and targets for providing Total Quality Management in Real Time with management, design and construction key performance indicators. The requirement management system identifies random audit samples to be taken and evaluated for compliance. This information is collected and reported in Real Time.

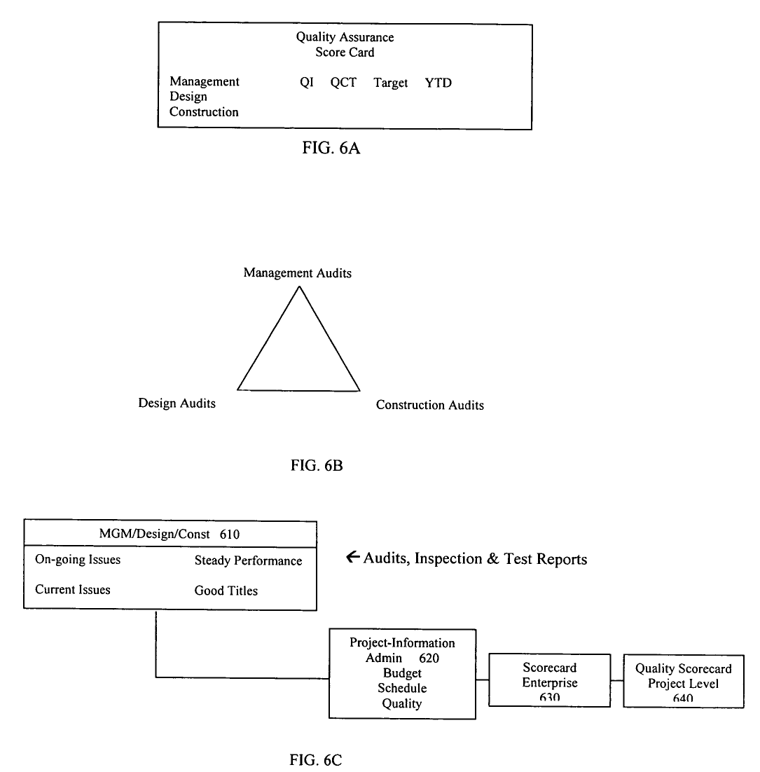

The system makes use of a Real Time Score Card as exemplified in FIG. 6A. The score card shows quality index (QI), quality control trend (QCI), target, and year to date (YTD) information, among others. The score card can provide Lead and Lagging Indicators that trigger user alerts based on defined action levels. Monthly Quality Status Reports such as the report shown in FIG. 6B can be generated for managing the construction project based on management, design and construction audits and test results.

FIG. 6C shows an exemplary report that shows On-going Issues, Current Issues and Issues under control based on quality and risk levels (610). The report can track and show Project-Information (620) such as administration, budgeting, scheduling, and quality information impacts. The report can also show scorecards 630-640 at the enterprise and project levels.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A computer-implemented method to monitor pavement hot-mix material quality, comprising:
collecting quality control data in real-time from one of: a plant, a truck, a lay-down equipment, a paver;
accessing a server located on a wide-area-network;
sending information collected from the materials, components or blends to the server;
applying one or more test or inspection methodologies to the collected information;
generating one or more quality management reports from the test methodologies; and
sending the one or more quality management reports to a reviewer.

2. The computer-implemented method of claim 1, further comprising applying aggregate test methodologies.

3. The computer-implemented method of claim 2, wherein the aggregate test methodologies include one or more of the following: Los Angeles Abrasion; Soundness Test; 24 Hours Water Absorption Sand Equivalent; Unit Weight and Voids in Aggregate; Specific Gravity, Water Absorption and Moisture; and Clay Lumps and Friable Particles in Aggregate.

4. The computer-implemented method of claim 1 further comprising applying soil test methodologies.

5. The computer-implemented method of claim 5, wherein the soil test methodologies include one or more of the following: Soil Liquid, Plastic Limit and Plasticity Index; Material in Soil Finer Than #200 Sieve; Moisture and Density of Soil-Aggregate In-Place by Nuclear Method; Moisture Content; Specific Gravity of Soil; Unconfined Compressive Strength of Cohesive Soil; Sieve Analysis; and Compaction Test.

6. The computer-implemented method of claim 1, further comprising applying asphalt test methodologies.

7. The computer-implemented method of claim 6, wherein the asphalt test methodologies include one or more of the following: Extraction; AES300 Emulsion Test; and ARA-1 Rejuvenate Agent.

8. The computer-implemented method of claim 1, further comprising applying asphalt mix test methodologies.

9. The computer-implemented method of claim 8, wherein the asphalt mix test and inspection methodologies include one or more of the following: Ignition Test; Actual Specific Gravity; Theoretical Maximum (Rice) Specific Gravity;
Tensile Strength Ratio; Marshall Stability; Hveem Stability and Voids Calculation.

10. The computer-implemented method of claim 1, further comprising applying concrete mix test methodologies.

11. The computer-implemented method of claim 11, wherein the concrete mix test methodologies include one or more of the following: Unit Weight, Yield, Air Content of Mix; Flexural Strength; Compressive Strength of Cylindrical Concrete Specimens; and Air Content.

12. The system of claim 12, further is comprising statistically comparing test results for engineering analysis and in determining pay factor adjustments and material acceptance.

13. A system for capturing data and analyzing construction material components and mixtures quality, comprising:
a wide-area-network;
one or more real-time sensors mounted on one of: a plant, a truck, a lay-down equipment, a paver;
one or more client computers coupled to the wide-area-network, each client computer adapted to collect information relating to material properties; and
a server coupled to the wide-area network, the server applying one or more test methodologies to the collected information; generating one or more reports from the test methodologies; and sending the one or more reports to a project manager.

14. The system of claim 13, comprising quality assurance means for performing one or more of: quality control, quality acceptance, quality verification, quality validation, independence assurance, quality audits, contractor informational testing and inspection and others on construction material and or its components for design and installation of approved mix design submittals and such that the receipt is monitored for quality.

15. The system of claim 13, comprising means to perform statistical comparison of aggregate, asphalt, soils, and concrete test methodologies performed by various quality assurance laboratories and field technicians.

16. The system of claim 13, comprising means for applying quality compliance audits of testing methodologies, technicians, equipment, and contract specification and deliverables.

17. The system of claim 13, wherein collection field-testing and inspection audits are performed using portable computers for construction material components and mixtures and installation.

18. The system of claim 13, comprising a requirement management system to perform compliance audits of request for proposal requirements and providing audit status reports for management, design and construction key performance indicators of design and construction contract specifications items and tests.

19. The system of claim 13, wherein quality information for tests and inspection and audits comprise key performance indicators to drive a real-time quality assurance scorecard by comparing, monitoring, and tracking quality trends, issues and goals based on management, design, and construction criteria.

20. The system of claim 13, comprising means for applying trend analysis and correlation to generate electronic alerts and notifications when action levels, upper or lower limits, or performance indicators violate predetermined event triggers.
